(19) United States
(12) Patent Application Publication
(10) Pub. No.: US 2015/0198989 A1
(43) Pub. Date: Jul. 16, 2015

(54) SYSTEM AND METHOD FOR UTILIZING A UNIVERSAL SERIAL BUS POWER SOURCE TO POWER A COMPUTER DEVICE

(71) Applicant: Google Inc., Mountain View, CA (US)

(72) Inventor: Mark D. Hayter, Menlo Park, CA (US)

(73) Assignee: Google Inc., Mountain View, CA (US)

(21) Appl. No.: 13/837,567

(22) Filed: Mar. 15, 2013

(51) Int. Cl. G06F 1/26

(52) U.S. Cl. CPC G06F 1/263

(57) ABSTRACT

An apparatus (e.g., a computer device) includes a power system. The power system includes a universal serial bus (USB) adapter communicatively coupled to a USB power source with a power bus, a first controller configured to increase a current associated with the USB power source, a second controller configured to determine a power utilization of the computer device, and a third controller configured to couple a battery to the power bus based on the determined power utilization such that a current associated with the USB power source does not exceed a threshold current rating of the USB power source. The apparatus includes a display configured to inform a user of the device of a power limitation of the USB power source based on the determined power utilization.

### FIELD

Embodiments relate to powering computer devices (e.g., laptop computers) utilizing a universal serial bus (USB) power source.

### BACKGROUND

USB ports are included on many computer devices on the market today. Typically the USB interface is utilized for communications with peripheral devices (e.g., printers and scanners) external to the computer devices. Other external devices (e.g., cell phones) can utilize a USB port of a computer device as a power source for charging the device battery of the external devices. However, computer devices are not typically powered through a USB power source because the USB power source may not provide sufficient power capacity for charging the battery of the computer device and/or for powering the computer device.

### SUMMARY

One embodiment includes an apparatus (e.g., a computer device) including a power system. The power system includes a universal serial bus (USB) adapter communicatively coupled to a USB power source with a power bus, a first controller configured to increase a current associated with the USB power source, a second controller configured to determine a power utilization of the computer device, and a third controller configured to couple a battery to the power bus based on the determined power utilization such that a current associated with the USB power source does not exceed a threshold current rating of the USB power source. The apparatus includes a display configured to inform a user of the device of a power limitation of the USB power source based on the determined power utilization.

Another embodiment includes an apparatus including a universal serial bus (USB) adapter communicatively coupled to a USB power source with a battery, a first controller configured to increase a current associated with the USB power source, a second controller configured to determine a power utilization of the apparatus, and a display configured to display a power limitation of the USB power source based on the determined power utilization.

Still another embodiment includes a method including increasing a current associated with a universal serial bus (USB) adapter communicatively coupled to a USB power source with a battery, determining a power utilization of a device including the USB adapter, and displaying, on the device, a power limitation of the USB power source based on the determined power utilization.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1A illustrates a power system according to an example embodiment.

FIG. 1B illustrates a graph of boost voltage versus input current for the power system illustrated in FIG. 1A.

FIG. 2 illustrates a power system according to an example embodiment.

FIG. 3 illustrates a power adapter according to an example embodiment.

FIG. 4 illustrates a detector according to an example embodiment.

FIG. 5 illustrates a display system according to an example embodiment.

FIG. 6 illustrates a method for utilizing universal serial bus (USB) power according to an example embodiment.

FIG. 7 illustrates a method for displaying remaining power according to an example embodiment.

FIG. 8 illustrates a flowchart showing functions performed by the system controller 205 to prevent excessive discharge from the battery 210.

FIG. 9 illustrates a flowchart showing functions performed by the control circuit to prevent the battery from charging too quickly.

FIG. 10 illustrates a flowchart showing functions performed by the control circuit to check whether the battery is functioning.

FIG. 11 illustrates a flowchart showing functions performed by the control circuit to increase the voltage presented by the charger to the battery when the power system is receiving power from the USB or an auxiliary power source.

FIG. 12 illustrates a flowchart showing functions performed by the control circuit to allow current to flow to or from the battery depending on whether the power received by the power system meets the requirements of the load(s).

FIG. 13 illustrates a block diagram of a system in accordance with an example embodiment.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of layers, regions and/or structural elements may be reduced or exaggerated for clarity. The use of similar or identical reference numbers in the various drawings is intended to indicate the presence of a similar or identical element or feature.

### DETAILED DESCRIPTION OF THE EMBODIMENTS

While example embodiments can have various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Example embodiments may provide an apparatus (e.g. a computer or a mobile device. The apparatus may include a universal serial bus (USB) adapter communicatively coupled to a USB power source with a power bus, a controller configured to increase and/or set a maximum current associated with the USB power source, another controller configured to determine a power utilization of the computer device, and still another controller configured to couple a battery to the power bus based on the determined power utilization such that a voltage associated with the USB power source does not exceed a threshold (e.g., maximum) voltage rating of the USB power source.

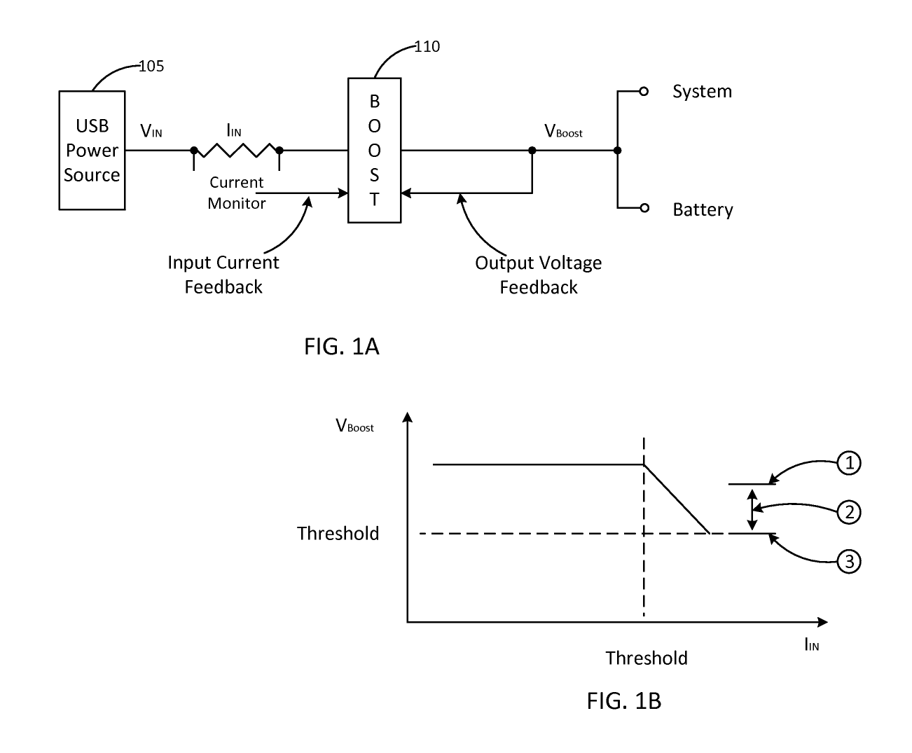

FIG. 1A illustrates a power system according to an example embodiment. FIG. 1B illustrates a graph of boost voltage versus input current for the power system illustrated in FIG. 1A. As shown in FIG. 1A, the power system includes a power source block 105 (e.g., a universal serial bus (USB) power source or power brick) and a boost block 110. The power source 105 may provide a voltage V_{IN} and such that an input current I_{IN} is drawn by the power circuit. The boost block 110 may be configured vary boost voltage V_{BOOST} based on input current I_{IN} and the boost voltage V_{BOOST}.

As shown in FIG. 1B, the input current I_{IN} may have an input current threshold and the boost voltage V_{BOOST} may have a boost voltage threshold. The input current threshold may be set such that an input current I_{IN} less than the input current threshold results in the power system operating solely on the power source block 105 and an input current I_{IN} greater than the input current threshold results in the power system operating based on both the power source block 105 and a battery. The boost voltage threshold may be a boost voltage V_{BOOST} below which the power system does not operate properly.

As shown in FIG. 1B, the power system may operate in one of three states. In state 2, the power system operates solely on the boost voltage V_{BOOST} and the battery is not charged. In state 3, the power system operates on both the boost voltage V_{BOOST} and the battery. In state 1, the system operates only on the boost voltage excess power may be used to charge the battery. If there is no power on V_{IN}, the power system operates solely on the battery. As a result, the boost block 110 may be configured vary boost voltage V_{BOOST} based on input current I_{IN} and the boost voltage V_{BOOST} such that if the input current I_{IN} is less than the input current threshold, the boost voltage V_{BOOST} is set by the output voltage feedback (based on the boost voltage V_{BOOST}) and if the input current I_{IN} is greater than the input current threshold, the boost voltage V_{BOOST} is reduced by the input current feedback (based on input current I_{IN}).

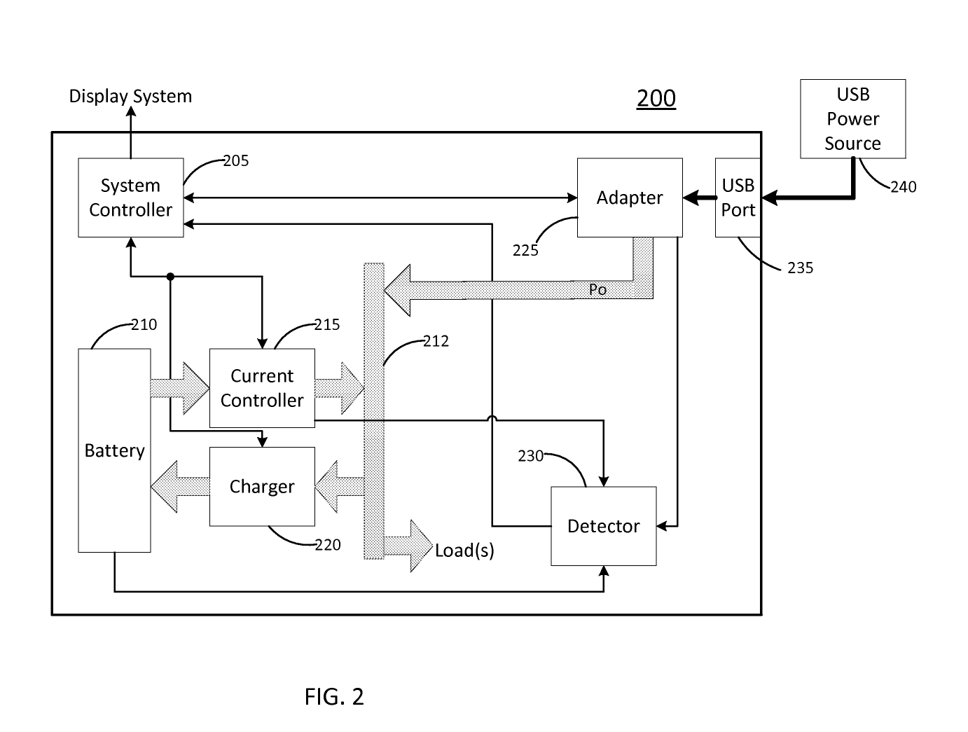

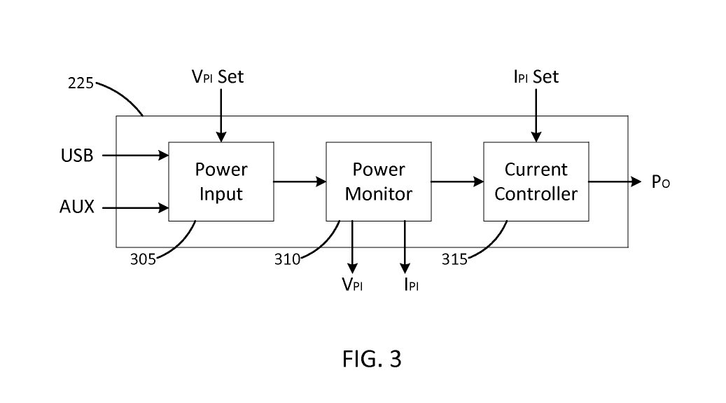

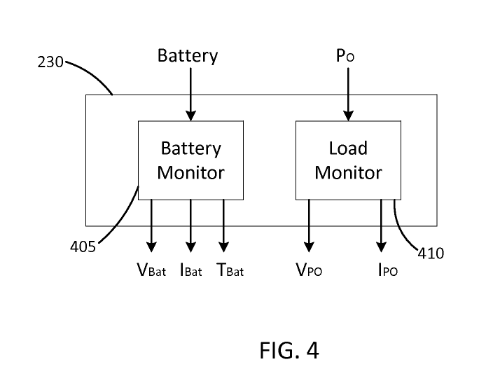

FIG. 2 illustrates a power system 200 according to an example embodiment. As shown in FIG. 2, the power system 200 includes a system controller 205, a battery (e.g., a rechargeable battery) 210, a battery current controller 215, a charger 220, a adapter 225, a detector 230, a universal serial bus (USB) port 235, and a universal serial bus (USB) power source 240. The power system 200 includes a power bus 212 and various control signal lines. The adapter 225 and detector 230 are described below in more detail with regard to FIGS. 3 and 4. The universal serial bus (USB) power source 240 may be any known USB power source (e.g., a wall outlet or computer device with a USB adapter that can be inserted into a USB port).

The system controller 205 may be configured to determine a power utilization of a computer device (e.g. computer device 2400 or mobile computer device 2450 described below) including the power system 200. The system controller 205 may be configured to couple the battery 210 to the power bus 212 based on the determined power utilization such that a current associated with the USB power source 240 does not exceed a threshold current rating of the USB power source 240. For example, the system controller 205 may utilize information received from the adapter 225, the detector 230 and the battery current controller 215 to determine power utilization of the computer device. For example, the computer device may include one or more loads (e.g., monitor 1316 and processor 1302 described below). The power associated with the one or more loads may be characterized by a voltage and/or a current as measured by detector 230 (including load monitor 410 described below) based on a power output. The detector 230 may communicate the voltage and current to the system controller 205.

The system controller 205 may also measure voltage, current, and/or power provided by the USB power source 240. For example, the adapter 225 may monitor voltage, current and/or power (e.g., using power monitor 310 described below). The adapter 225 may determine a voltage and a current representing the power delivered by (e.g., produced by) the USB power source 240. The adapter 225 may communicate the voltage and/or the current delivered by the USB power source 240 to the system controller 205.

The system controller 205 may determine the power utilization of the computer device based on the difference between the measured voltage, current, and/or power of the adapter 225 and the detector 230. If the power associated with the adapter 225 is equal to the power associated with the detector 230, system controller 205 may instruct the charger 220 not to charge the battery 210 and instruct the battery current controller 215 to disconnect the battery from the power bus 212. If the power associated with the adapter 225 is greater than the power associated with the detector 230, system controller 205 may instruct the charger 220 to charge the battery 210.

If the power associated with the adapter 225 is less than the power associated with the detector 230, system controller 205 may instruct the battery current controller 215 to supplement the power bus 212 with power from the battery 210 thus limiting the power draw (and peak current) on the USB power source 240. If the power associated with the adapter 225 is less than the power associated with the detector 230, system controller 205 may instruct the adapter 225 to limit a current to a threshold current rating. For example, if the adapter 225 is set such that a maximum (a threshold and/or approaching maximum) current is pulled from the USB power source 240 and the power associated with the adapter 225 is less than the power associated with the detector 230 (e.g., the computer is drawing more power than the USB power source 240 is providing), the voltage on the power bus 212 may fall to match the battery 210 voltage and the battery starts providing power to the system.

In another example embodiment, system controller 205 may provide information to a display, an indicator light, and/or the like based on the power utilization. The display may be configured to inform a user of the computer device of a power limitation of the USB power source 240 based on the determined power utilization. For example, the user of the computer device may erroneously assume that because the computer device is plugged into the USB power source 240, the computer device has a virtually unlimited power supply. This assumption is incorrect when the battery 210 is providing additional power to satisfy the power demand of the computer device in addition to the power already being provided by the USB power source 240. In other words, this assumption is incorrect because the USB power source 240 is unable to supply sufficient power to meet the demand of the computer device, resulting in a drain of power from the battery 210. Therefore, providing the user of the computer device with a visual indication of limitation of (e.g., inability of) the USB power source 240 to satisfy the overall power needs of the may be beneficial.

The system controller 205 may include a processor, one or more interfaces and a memory (not shown). The system controller 205 may be communicatively coupled with and receive from/transmit to the adapter 225, battery current controller 215, the charger 220 and the detector 230. For example, the system controller 205 may receive voltage and current information (e.g., V_{PI}, I_{PI}, V_{Bat}, I_{Bat}, V_{PO}, and I_{PO} shown in FIGS. 3 and 4) from the adapter 225 and the detector 230. The system controller 205 may utilize the voltage and current information to determine voltage and current settings (e.g., VPI Set and IPI set) associated with the adapter 225 and transmit these settings to the adapter 225. The system controller 205 may also determine values for input to the battery current controller 215 and the charger 220 and transmit these values to the battery current controller 215 and the charger 220.

The battery current controller 215 may be configured to limit the flow of current from the battery 210 to the load to prevent excessive discharge of power from the battery 210, which may damage the battery 210. The battery current controller 215 may limit this current flow to prevent damage to the battery or excessive drain or discharge of the battery.

The battery current controller 215 may limit the current flow from the battery 210. The battery current controller 215 may, for example, include one or more switches (e.g., transistors, such as field-effect transistors) such that the resistance of the path through which current flows is varied.

In an example implementation, the battery current controller 215 may include a switch (e.g., a transistor, such as field-effect transistors (FETs)). The switch may, based on instruction from the system controller 205, disconnect the battery 210 from the power output Po if the voltage level at the power output Po is higher than a safe voltage for the battery 210, or if the USB power source 240 is not providing power and the energy level of the battery 210 is to low, thereby preventing damage to the battery 210.

The charger 220 may include a DC-to-DC converter, and/or a switching converter, which increases the voltage at the battery 210 compared to the voltage at the power output Po. The charger 220 may decouple the voltage level at the battery 210 from the voltage at the power output Po. The charger 220 may allow (or cause) current to flow from the power output Po to the battery 210, but not from the battery 210 to the power output Po. The charger 220 may step up voltage seen by the battery 210 so that if the voltage level at the power output Po is too low for the battery 210 to receive current and recharge, the battery 210 may still receive current and power from the USB power source 240 via the power output Po. The charger 220 may include, for example, a switching charger or boost converter which steps up the voltage seen by the battery 210 from the voltage at the power output Po. The charger 220 may increase the voltage based on a determination by the charger 220 that the voltage level at the battery 210 is insufficient to recharge the battery 210, or based on a determination by the control circuit that the voltage level at the battery 210 is insufficient to recharge the battery 210.

The system controller 205 may instruct a processor associated with the computer to limit one or more processing functions based on a charge (or amount of power) remaining in the battery 210. The one or more processing functions may affect a power consumption of the computer device. For example, the one or more processing functions may include executing background processes (e.g., virus scanning), internet access, and the like.

FIG. 3 illustrates the adapter 225 according to an example embodiment. As shown in FIG. 3, the adapter 225 includes a power input 305, a power monitor 310, and a current controller 315. The adapter 225 may be a controller configured to increase a current associated with the USB power source, a second controller configured to determine a power utilization of the computer device. The current may be increased by the adapter 225 by increasing the current draw by the adapter 225 (and as a result the device including the adapter).

The power input 305 may include a powered device, such as a voltage converter, and may include an auxiliary input function. The power input 305 may receive power from the USB power source 240. The power input 305 may also optionally receive power from the auxiliary power source. The auxiliary power source may include, for example, an electrical wall outlet that provides AC power. The power input 305 may set a voltage provided to a next module based on input received from the system controller 205.

The power input 305 may, for example, receive a target power and/or voltage setting (e.g., voltage power input set signal V_{PI} Set) from the system controller 205 shown in FIG. 2. The power input 305 may respond to the voltage power input set signal by setting a voltage provided to the power monitor 310 based on the received voltage power input signal. The power input 305 may set the voltage by combining the power received from the USB power source 240 with the auxiliary power. The power input 305 may, for example, convert the auxiliary power from AC power into DC power, and combine the converted DC power with the DC power of the USB power source 240. The power input 305 may also function as a digital-to-analog converter (DAC), controlling the output voltage to twelve volts or between seven and eighteen volts, depending on the requirements (e.g., number of cells) of the battery.

The power input 305 may receive a target power and/or voltage setting (e.g., voltage power input set signal V_{PI} Set) of either one or two bits, setting the voltage at one of either two or four points within a voltage range (e.g., between seven and eighteen volts). The power input 305 may also include a voltage drop which drops the voltage to the desired voltage level if the voltage level of power received by the power input 305 is greater than the voltage level indicated by the voltage power input set signal. The power input 305 may combine and/or drop the voltage based on a voltage power input set signal received from the control circuit. Changing the voltage at the power input 305 based on the voltage power input set signal controls the voltage at the power output Po.

The power monitor 310 may be coupled to the power input 305, and may monitor the voltage level provided by the power input 305, as well as current flowing from the power input 305. The power monitor 310 may include, for example, a shunt resistor and a measuring device. The power monitor 310 may provide the monitored power, voltage level and current to the system controller 205. The system controller 205 may determine the power utilization of the computer device based on the difference between the measured voltage, current, and/or power of the adapter 225 and the detector 230 as described above. From the adapter 225, the current may flow from the power input 305 to the power monitor 310 to a current controller 315.

The current controller 315 may control the current flowing from the power input 305 and power monitor 310 to a power output Po. The current controller 315 may control the current based on a signal, such as a current power input set signal, received from the system controller 205. The current controller 315 may include, for example, a transistor, such as a field-effect transistor, and may limit the current flow from the power input 305 to the power output Po by changing an effective resistance between the power monitor 310 and the power output Po. The current controller 315 may, for example, limit the current flowing from the USB power source 240 to reduce the load placed on the USB power source 240 by the power system 200 by decreasing the effective resistance between the power monitor 310 and the power output Po.

The current controller 315 may limit the current flow to reduce the load on the USB power source 240. For example, the system controller 205 may have a maximum current setting at which the USB power source 240 may safely operate. The maximum current setting at which the USB power source 240 may safely operate may be communicated during an initial communications set-up. The current controller 315 may limit the power consumption of the power system 200 from the USB power source 240 so as not to overload the USB power source 240.

The current controller 315 may include a digital-to-analog controller (DAC), controlling the current flowing from the power monitor 310 through the current controller 315 to the power output Po. For example, the DAC may be a Pulse Width Modulation (PWM) based DAC with 8-bits or 256 levels. The current controller 315 may receive the current power input set signal (I_{PI} Set) from the system controller 205, which may include a number of bits (e.g., one or two bits for two or four set points). The one or two bits may set the current flowing through the current controller 315 at target set points, which may correspond to desired power draws from the USB power source 240, such as 2.5 watts or 4.5 watts.

FIG. 4 illustrates a detector 230 according to an example embodiment. As shown in FIG. 4, the detector 230 includes a battery monitor 405 and a load monitor 410. The detector 230 may be a controller configured to determine a power utilization of the computer device

The battery monitor 405 may be communicatively coupled with the battery 210 and the battery current controller 215. The battery monitor 405 may include, for example, a shunt resistor and a measuring device. The battery monitor 405 may measure a voltage level at the battery and a current flow between the battery 210 and the power bus 212. The battery monitor 405 may communicate signals to the system controller 205. The signals (e.g., V_{BAT}, I_{BAT}) indicating the measured voltage level at the battery and the current flow between the battery 210 and the power bus 212.

The load monitor 410 may be communicatively coupled with the power output Po and may measure a voltage at the power output Po and a current flow from the power output Po to one or more loads. The loads may include, for example, a display of the computing device. The load monitor 410 may include, for example, a shunt resistor and a measuring device. The load monitor 410 may communicate signals to the system controller 205. The signals (e,g., V_{PO}, I_{PO}) indicating the voltage of the power output Po and the current from the power output Po to the one or more loads. The voltage of the power output Po monitored by the load monitor 410 may also be the voltage at the load coupled to the load monitor 410. The load coupled to the load monitor 410 may be a load, such as a backlight with light-emitting diodes (LEDs), a liquid crystal display (LCD), processor (each of the computing device) and the like.

An example embodiment includes computer device including a display system. The display system includes a universal serial bus (USB) adapter communicatively coupled to a USB power source with a battery, a controller configured to increase a current associated with the USB power source, a detector configured to determine a power utilization of the computer device, and a display configured to inform a user of the device of a power limitation of the USB power source based on the determined power utilization.

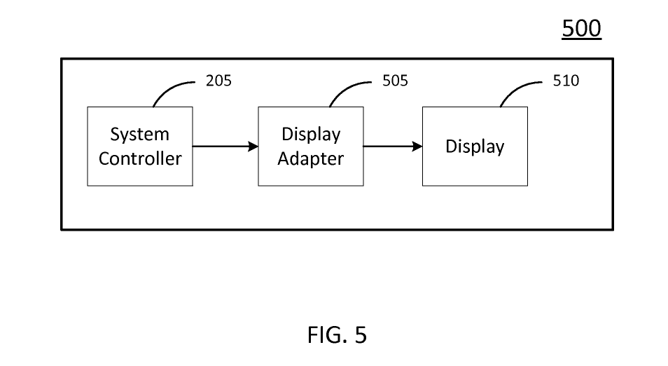

FIG. 5 illustrates a display system 500 according to an example embodiment. As shown in FIG. 5, the display system 500 includes the system controller 205, a display adapter 505 and a display 510. The system controller 205 is the system controller 205 described above with regard to FIG. 2 and includes one or more of the interfaces, inputs and interactions described above with regard to FIG. 2.

As described above, the system controller 205 may determine the power utilization of the computer device based on the difference between the power measurements of the adapter 205 (including the power monitor 310) and the detector 230 (including the load monitor 410). If the power associated with the power monitor is less than the power associated with the load monitor, system controller 205 may instruct the battery current controller 215 to supplement the power bus 212 with power from the battery 210.

Accordingly, the system controller 205 may provide information to a display (and/or an indicator) based on the power utilization. The display may be configured to inform a user of the computer device of a power limitation of the USB power source 240 based on the determined power utilization. For example, the user of the computer device may assume that because the computer device is plugged into the USB power source 240, the computer device computer device has a virtually unlimited power supply. However, this assumption may be incorrect when the battery 210 is providing additional power to satisfy the power demand of the computer device. The system controller 205 may output a signal to the display adapter. The signal may include power provided by the USB power source 240, power consumption of the computer device, power provided by the battery, power remaining in the battery, battery charge remaining as extended by the USB power source, and the like.

For example, the system controller 205 may determine a time remaining before the battery will be some percentage of fully discharged based on the power supplemented by the USB power source 240. If the USB power source 240 were in use and the USB power source 240 is providing additional power, the time remaining before the battery will be some percentage of fully discharged may be longer than if the USB power source 240 were not in use.

The display adapter 505 may generate an icon to be displayed on a display 510. The icon may inform a user of the device of a power limitation of the USB power source based on the determined power utilization. The icon may be a simple indicator like a warning light and the like. The icon may be a complex indicator like a power meter showing power and or time remaining The display 510 may be any type of display (e.g., LCD or LED). The icon may indicate at least one of no power attached, USB power attached and will be used to extend battery life (depending on load), USB power attached and will be used to charge battery or extend battery life, USB power attached and charging battery, and USB power attached and battery fully charged.

The system controller 205 may instruct the display adapter 505 to change one or more display parameters based on a charge (or amount of power) remaining in the battery 210. The one or more display parameters may affect a power consumption of the display. For example, the one or more display parameters may include a backlight setting, a sharpness setting, a contrast setting, a brightness setting, a number of pixels setting and the like.

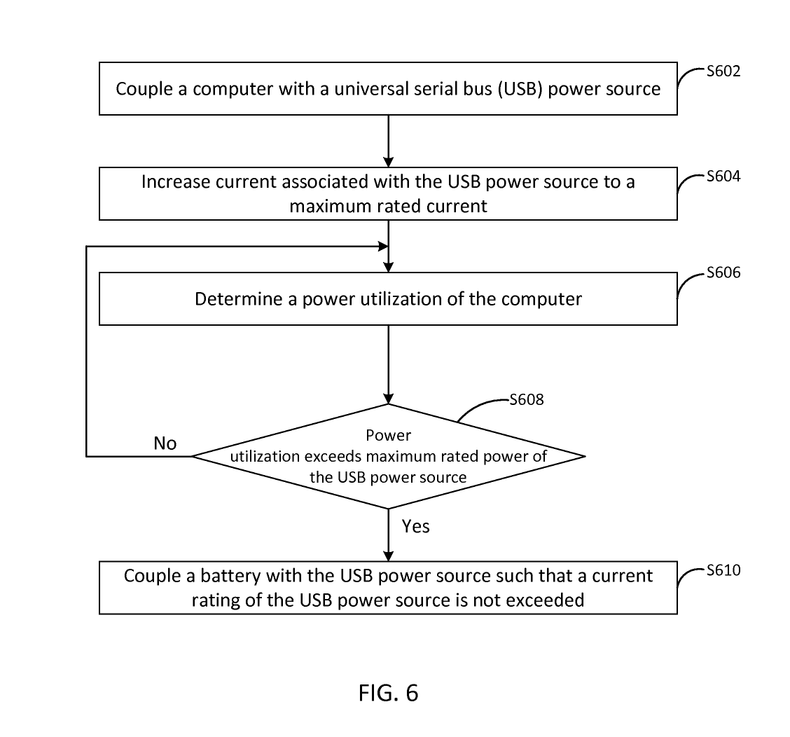

FIG. 6 illustrates a method for utilizing universal serial bus (USB) power according to an example embodiment. As shown in FIG. 6, in step S602, the system controller 205 couples the computer with the USB power source 240. For example, following the physical interconnection of the computer with the USB power source 240, the controller 205 may execute a known USB communications protocol in order to establish the communicative link. Following the completion of the USB communications protocol the controller 205 may determine the USB power source 240 is a standard power “brick” (e.g., a wall outlet adapter) or another communications device (e.g., another computer). Alternatively, the controller 205 may set the USB power source 240 as a standard power “brick” (e.g., a wall outlet adapter) or another communications device (e.g., another computer) based on the use of the USB communications protocol. For example, a standard power “brick” or another communications device may be required by the USB communications protocol.

In step S604, the system controller 205 increases a current associated with the USB power source 240 to a maximum (a threshold and/or approaching maximum) rated current. For example, the system controller 205 may output a current setting (e.g., I_{PI} Set) as an input to the current controller 315. The current setting may be a maximum rated current of the USB power source 240 as determined during the execution of the USB communications protocol. The maximum rated current of the USB power source 240 may be, for example, 100 mA, 500 mA or 1.8 A.

In step S606, the system controller 205 determines a power utilization of the computer. For example, the system controller 205 may utilize information received from the adapter 225, the detector 230 and the battery current controller 215 to determine power utilization of the computer device. For example, the computer device may include one or more loads (e.g., monitor and processor). The power associated with the one or more loads may be characterized by a voltage and a current as measured by a load monitor (e.g., load monitor 410 described below) based on a power output Po. The load monitor may communicate the voltage and current to the system controller 205

The system controller 205 may also measure power provided by the USB power source 240. For example, the adapter 225 may include a power monitor (e.g., power monitor 310 described below). The power monitor may determine a voltage and a current representing the power delivered by the USB power source 240. The power monitor may communicate the voltage and current to the system controller 205. The system controller 205 may determine the power utilization of the computer device. For example, the power utilization may be based on the power associated with the one or more loads may be characterized by a voltage and/or a current as measured by detector 230 (including load monitor 410) as described above.

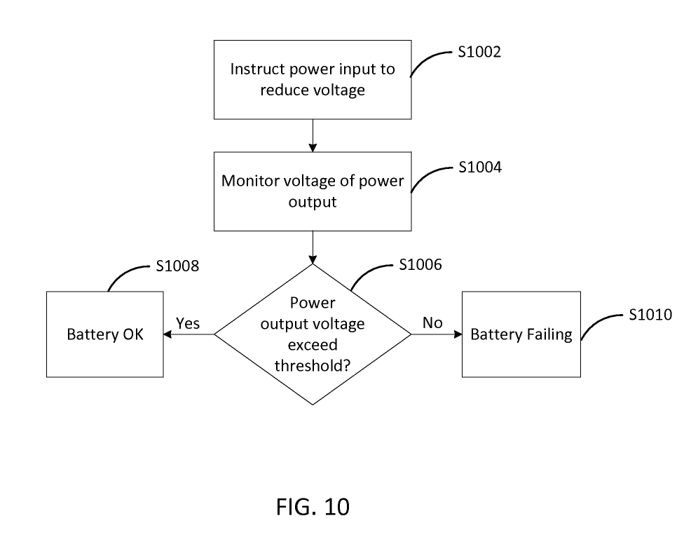

In step S608, if the system controller 205 determines the power utilization does not exceed a maximum rated power of the USB power source 240, processing returns to step S606. Alternatively (or in addition to), the system controller 205 may utilize the USB power source 240 to charge battery 210 as discussed above (and with regard to FIG. 10 below). Otherwise, processing proceeds to step S610.

In step S610, the system controller 205 couples the battery 210 to the power bus 212 (and as a result the USB power source 240) such that a current rating of the USB power source is not exceeded. For example, if the power associated with the power monitor 310 is less than the power associated with the load monitor 410, system controller 205 may instruct the battery current controller 215 to supplement the power bus 212 with power from the battery 210 thus limiting the power draw (and peak current) on the USB power source 240, which may prevent exceeding the rating of the USB power source. For example, if the adapter 225 is set such that a maximum current is pulled from the USB power source 240 and the power associated with the power monitor is less than the power associated with the load monitor (e.g., the computer is drawing more power than the USB power source 240 is providing), a current associated with the USB power source 240 will increase in order to meet the power demand. According to an example embodiment, the current associated with the USB power source 240 may not increase because the battery 210 provides the additional power to satisfy the power demand of the computer device. The steps of FIG. 6 may be repeated beginning at step S606, for example.

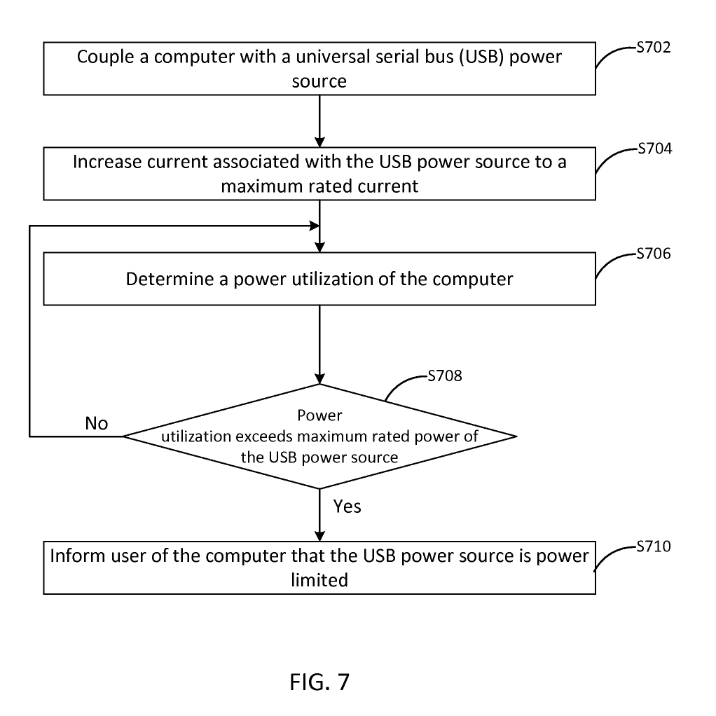

FIG. 7 illustrates a method for displaying remaining power according to an example embodiment. As shown in FIG. 7, in step S702, the system controller 205 couples the computer with the USB power source 240. For example, following the physical interconnection of the computer with the USB power source 240, the controller 205 may execute a known USB communications protocol in order to establish the communicative link. Following the completion of the USB communications protocol the controller may determine the USB power source 240 is a standard power “brick” (e.g., a wall outlet adapter) or another communications device (e.g., another computer).

In step S704, the system controller 205 increases a current associated with the USB power source 240 to a maximum (a threshold and/or approaching maximum) rated current. For example, the system controller 205 may output a current setting (e.g., I_{PI} Set) as an input to the current controller 315. The current setting may be a maximum rated current of the USB power source 240 as determined during the execution of the USB communications protocol. The maximum rated current of the USB power source 240 may be, for example, 100 mA, 500 mA or 1.8 A.

In step S706, the system controller 205 determines a power utilization of the computer. For example, the system controller 205 may utilize information received from the adapter 225, the detector 230 and the battery current controller 215 to determine power utilization of the computer device. For example, the computer device may include one or more loads (e.g., monitor and processor). The power associated with the one or more loads may be characterized by a voltage and a current as measured by a load monitor (e.g., load monitor 410 described below) based on a power output Po. The load monitor may communicate the voltage and current to the system controller 205

The system controller 205 may also measure power provided by the USB power source 240. For example, the adapter 225 may include a power monitor (e.g., power monitor 310 described below). The power monitor may determine a voltage and a current representing the power delivered by the USB power source 240. The power monitor may communicate the voltage and current to the system controller 205. The system controller 205 may determine the power utilization of the computer device based on the difference between the power measurements of the power monitor and the load monitor.

In step S708, if the system controller 205 determines the power utilization does not exceed a maximum (a threshold and/or approaching maximum) rated power of the USB power source 240, processing returns to step S706. Otherwise, processing proceeds to step S710.

In step S710 the system controller 205 utilizes a display of the computer system to inform a user of the computer that the USB power source 240 is power limited. For example, the system controller 205 may determine the power utilization of the computer device based on the difference between the power measurements of the power monitor and the load monitor. If the power associated with the power monitor is less than the power associated with the load monitor, system controller 205 may instruct the battery current controller 215 to supplement the power bus 212 with power from the battery 210.

Accordingly, the system controller 205 may provide information to a display based on the power utilization. The display may be configured to inform a user of the computer device of a power limitation of the USB power source 240 based on the determined power utilization. For example, the user of the computer device may assume that because the computer device is plugged into the USB power source 240, the computer device computer device has a virtually unlimited power supply. However, this assumption is incorrect when the battery 210 is providing additional power to satisfy the power demand of the computer device. The system controller 205 may output a signal to the display adapter. The signal may include power provided by the USB power source 240, power consumption of the computer device, power provided by the battery, power remaining in the battery, battery charge remaining as extended by the USB power source 240, and the like.

For example, the system controller 205 may determine a time remaining before the battery will be some percentage of fully discharged based on the power supplemented by the USB power source 240. As one skilled in the art will appreciate, this time will be longer than if the USB power source were not in use.

The display adapter 505 may generate an icon to be displayed on a display 510. The icon may inform a user of the device of a power limitation of the USB power source based on the determined power utilization. The icon may be a simple indicator like a warning light and the like. The icon may be a complex indicator like a power meter showing power and or time remaining The icon may indicate at least one of no power attached, USB power attached and will be used to extend battery life (depending on load), USB power attached and will be used to charge battery or extend battery life, USB power attached and charging battery, and USB power attached and battery fully charged.

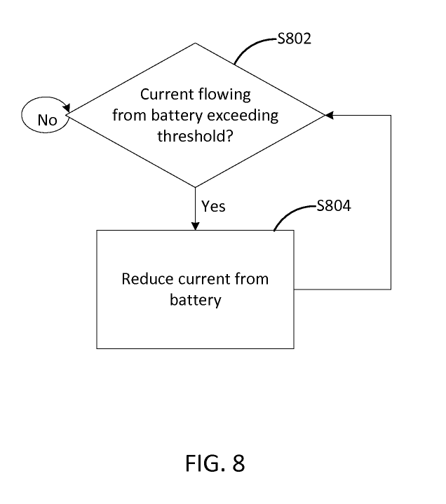

FIG. 8 is a flowchart showing functions performed by the system controller 205 to prevent excessive discharge from the battery 210. In step S802 the system controller 205 may determine whether current flowing from the battery 210 exceeds a threshold. For example, the current flowing from the battery 210 may exceed a threshold if an excessive load is applied to the system the battery 210 is providing power for. For example, the system controller 205 may compare the current flow indicated by the current battery signal received from the battery monitor 405 exceeds a safe battery current threshold. If no current is flowing from the battery 210, or if the current flowing from the battery 210 does not exceed the threshold, then no action may be performed.

In step S804 if the current flowing from the battery 210 is excessive and exceeds the safe battery current threshold, then the system controller 205 may instruct the battery 210 to turn off, or may instruct the battery current controller 215 to stop or reduce the current flowing from the battery 210.

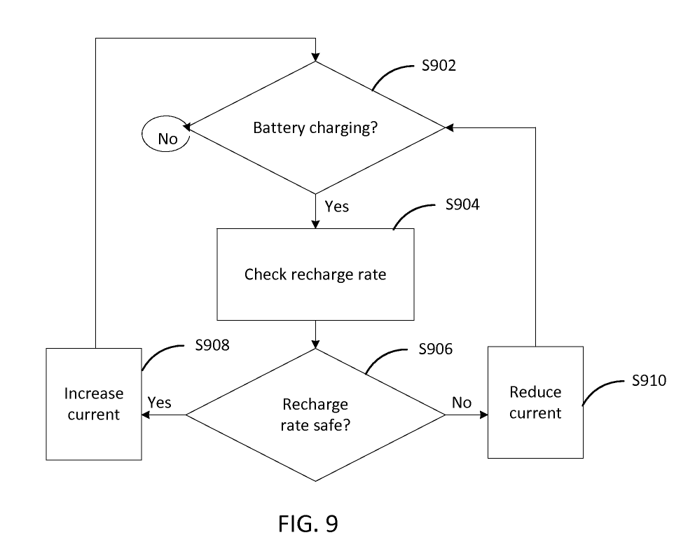

FIG. 9 is a flowchart showing functions performed by the system controller 205 to prevent the battery 210 from charging too quickly. If the battery 210 charges too quickly, the battery 210 may become damaged.

In step S902 the system controller 205 may determine whether the battery is charging. The system controller 205 may determine whether the battery is charging by checking whether the voltage level at the battery 210 as measured by the battery monitor 405 is less than the voltage at the power output Po as measured by the load monitor 210, or by checking whether there is current flow from the power output Po to the battery 210 as measured by the battery monitor 405. If the battery 210 is not charging, then the system controller 205 may continue to monitor whether the battery 210 is charging.

In step S904 if the battery 210 is charging, then the system controller 205 may check a recharge rate of the battery 210. The system controller 205 may check the recharge rate by determining a power rate, which may include multiplying the difference between the voltage level at the battery 210 and the voltage level at the power output Po by the current flow from the power output Po to the battery 210.

In step S906 the system controller 205 may compare the recharge rate to a safe recharge rate. In step S908 if the recharge rate does not exceed the safe recharge level, then the system controller 205 may continue to monitor the recharge rate, or may instruct the battery current controller 215 to continue to allow current flow or to increase the current flow. In step S910 if the system controller 205 determines that the recharge rate does exceed the safe recharge level, then the system controller 205 may instruct the battery current controller 215 to reduce or stop the current flowing from the power output Po to the battery 210.

FIG. 10 is a flowchart showing functions performed by the system controller 205 to check whether the battery 210 is functioning. The control circuit 210 may check whether the battery 210 is functioning on a periodic basis, such as monthly, weekly, or daily.

In step S1002 the system controller 205 may instruct the adapter 225 to reduce its voltage level. In step S1004 the system controller 205 may monitor the voltage at the power output Po. The system controller 205 may, for example, monitor the voltage at the power output Po by monitoring the voltage power output signal received from the load monitor 210 both before and after instructing the adapter 225 to reduce the voltage level. If the battery 210 is not providing any power to the power system 200 or is not functioning, then the voltage level at the power output Po may be expected to drop in response to the lowering of the voltage of the adapter 225, whereas if the battery 210 is providing power to the power system 200, then the voltage level at the power output Po may remain the same or remain at least at a threshold level.

In step S1006 the system controller 205 may determine whether the voltage level at the power output Po meets or exceeds the threshold level. In step S1108 if the voltage level at the power output Po does meet or exceed the threshold level, then the system controller 205 may determine that the battery 210 is functioning. The system controller 205 may send a signal to an administrator, or provide another output such as lighting a green diode, indicating that the battery 210 is functioning.

In step S1010 if the system controller 205 determines that the voltage level at the power output Po does not meet or exceed the threshold, then the system controller 205 may send a signal to an administrator, or provide another output such as lighting a red diode, indicating that the battery 210 is not functioning. An administrator may respond to the signal indicating that the battery 210 is not functioning by replacing the battery 210.

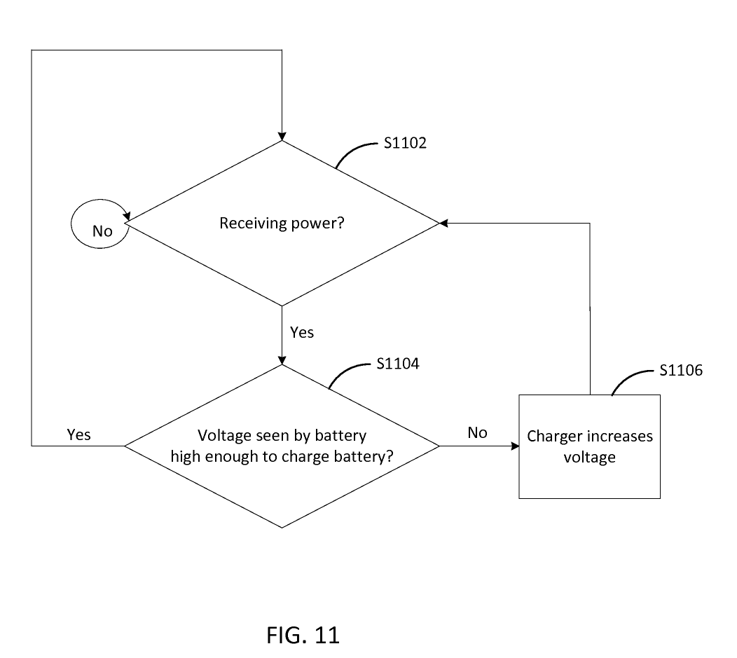

FIG. 11 is a flowchart showing functions performed by the system controller 205 to increase the voltage presented by the charger 220 to the battery 210 when the power system 200 is receiving power from the USB or an auxiliary power source. In step S1102 the system controller 205 may determine whether the power system 200 is receiving power. The system controller 205 may, for example, multiply the voltage measured by the power monitor 310 by the current monitored by the power monitor 310, or determine whether current is flowing from the USB through the power monitor 310 to the power output Po. If the power system 200 is not receiving power, then no action may be performed.

In step S1104 if the power system 200 is receiving power, then the system controller 205 may determine whether the voltage level at the battery 210 is sufficient or high enough to charge the battery. The system controller 205 may, for example, compare a voltage of the battery 210 as measured by the battery monitor 405 to a threshold value which is required to charge the battery 210. If the voltage at the battery 210 is high enough to charge the battery 210, then no action may be performed, and the system controller 205 may continue to monitor whether the power system 200 is receiving power (S1102).

In step S1106 if the voltage at the battery 210 is not high enough to charge the battery 210, then the system controller 205 may instruct the charger 220 to boost the power supply. The charger 220 may boost the power supply by stepping up the voltage at the battery 210 from the voltage at the power output Po. The battery 210 may then receive current and power from the USB via the power output Po. The battery 210 may thereby recharge.

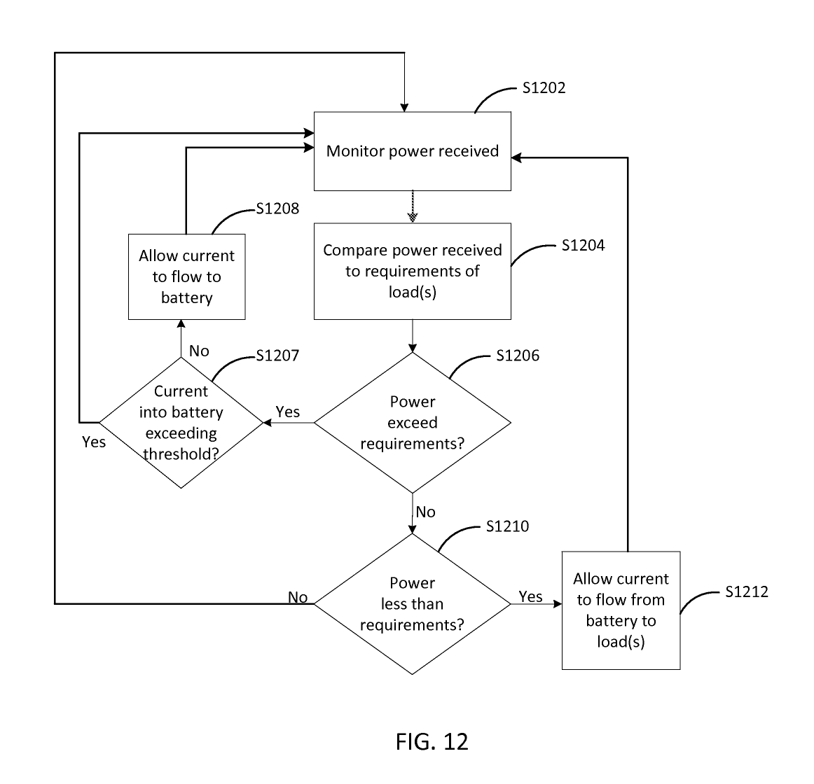

FIG. 12 is a flowchart showing functions performed by the system controller 205 to allow current to flow to or from the battery 210 depending on whether the power received by the power system 200 meets the requirements of the load(s). The system controller 205 may allow current to flow from the adapter 225, through the power output Po, to the battery 210, to recharge the battery 210 when the power received from the USB and/or auxiliary power source is greater than the power required to power the load(s). If the power received from the USB and/or auxiliary power is less than required or needed to power the load(s), then the control circuit may prevent current from flowing from the power output Po to the battery 210, and may allow current to flow from the battery 210 to the power output Po to compensate for the deficiency in power received compared to power required.

In step S1202 the system controller 205 may monitor the power received by the power system 200 from the USB and/or auxiliary power source. The system controller 205 may monitor the power received based, for example, on the voltage power input signal and the current power input signal received from the power monitor 310.

In step S1202 the system controller 205 may compare the power received to requirements of the load(s). The system controller 205 may, for example, have stored the power requirements of the load(s), and compare the received power, based on the signals received from the power monitor 310, to the stored power requirements. The system controller 205 may have stored a single power requirement for all loads supplied by the power system 200, or may store power requirements for each load supplied by the power system 200. The system controller 205 may, for example, add the power requirements for each of the loads currently in use or served by the power system 200, and compare the received power to the sum.

In step S1206 if the received power exceeds the requirements of the load(s) and in step S1207 if the system controller 205 determines the current flowing into the battery 210 is less than a threshold (e.g., the current into the battery is less than a safety threshold, such as whether the battery 210 is not charging too quickly and not at risk of becoming damaged), then in step S1208 the system controller 205 may allow current to flow to the battery 210. The system controller 205 may, for example, sent a current battery set signal to the current controller 214 instructing the current controller to allow current to flow from the power output Po to the battery 210 (through the battery monitor 405) and prevent current from flowing from the battery 210 to the current controller (through the battery monitor 405) to the power output Po. The current control 214 may, in response to receiving the current battery set signal, set a transistor(s) or diode(s) to allow current to flow from the power output Po to the battery 210 (through the battery monitor 405) and prevent current from flowing from the battery 210 to the current controller (through the battery monitor 405) to the power output Po.

In step S1206 if the received power does not exceed the requirements of the load(s), then in step S1210 the system controller 205 may determine whether the received power is less than the power required by the load(s). In step S1212 if the received power is less than the power required by the load(s), then the system controller 205 may allow current to flow from the battery 220 to the load(s) to compensate for the deficiency. The system controller 205 may, for example, sent a current battery set signal to the current controller 214 instructing the current controller to prevent current from flowing from the power output Po to the battery 210 (through the battery monitor 405) and allow current to flow from the battery 210 to the current controller (through the battery monitor 405) to the power output Po. The current control 214 may, in response to receiving the current battery set signal, set a transistor(s) or diode(s) to prevent current from flowing from the power output Po to the battery 210 (through the battery monitor 405) and allow current to flow from the battery 210 to the current controller (through the battery monitor 405) to the power output Po.

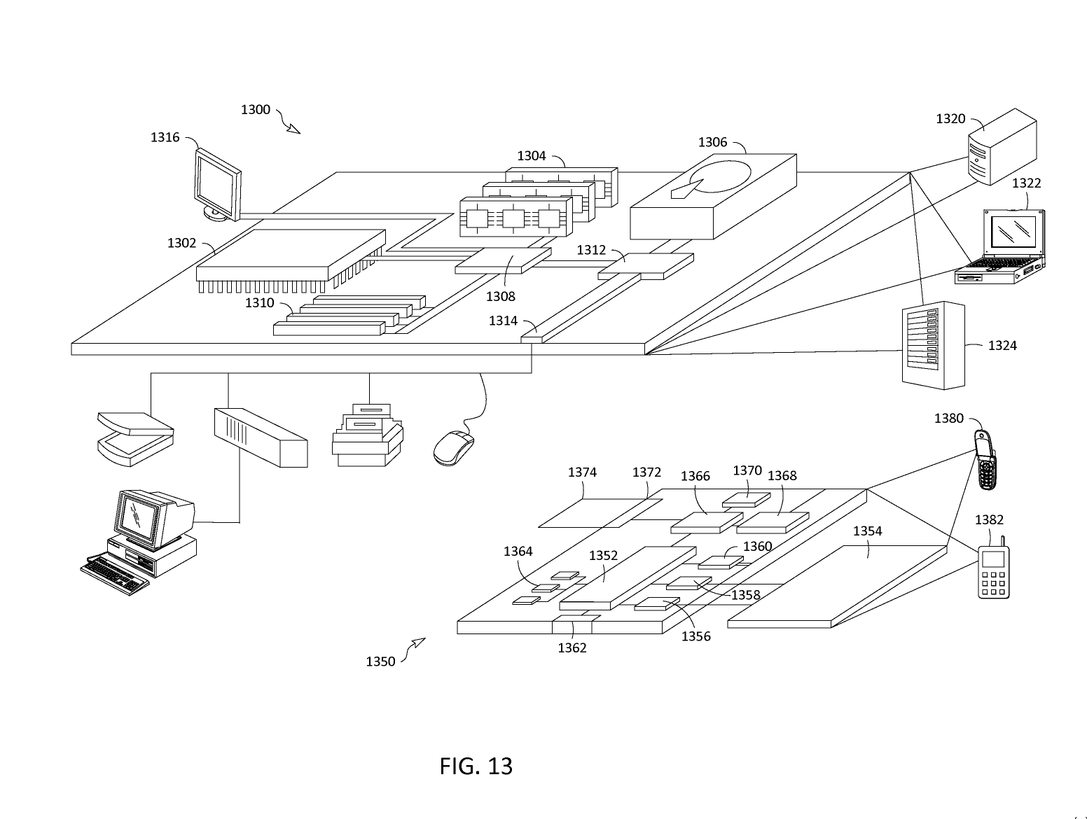

FIG. 13 illustrates a block diagram of a system in accordance with an example embodiment. FIG. 13 shows an example of a generic computer device 1300 and a generic mobile computer device 1350, which may be used with the techniques described herein. Computing device 1300 may represent various forms of digital computers, such as laptops, desktops, workstations, personal digital assistants, servers, blade servers, mainframes, and other appropriate computers. The power system 200 and the display system 500 may be elements of computing device 1300.

Computing device 1350 may represent various forms of mobile devices, such as personal digital assistants, cellular telephones, smart phones, and other similar computing devices. The power system 200 and the display system 500 may be elements of computing device 1350. The components shown here, their connections and relationships, and their functions, are meant to be exemplary only, and are not meant to limit implementations of example embodiments described and/or claimed in this document.

Computing device 1300 includes a processor 1302, memory 1304, a storage device 1306, a high-speed interface 1308 connecting to memory 1304 and high-speed expansion ports 1310, and a low speed interface 1312 connecting to low speed bus 1314 and storage device 1306. Each of the components 1302, 1304, 1306, 1308, 1310, and 1312, are interconnected using various busses, and may be mounted on a common motherboard or in other manners as appropriate. The processor 1302 can process instructions for execution within the computing device 1300, including instructions stored in the memory 1304 or on the storage device 1306 to display graphical information for a graphical user interface (GUI) on an external input/output device, such as display 1316 coupled to high speed interface 1308. In other implementations, multiple processors and/or multiple buses may be used, as appropriate, along with multiple memories and types of memory. Also, multiple computing devices 1300 may be connected, with each device providing portions of the necessary operations (e.g., as a server bank, a group of blade servers, or a multi-processor system, etc.).

The memory 1304 stores information within the computing device 1300. In one implementation, the memory 1304 includes a volatile memory unit or units. In another implementation, the memory 1304 includes a non-volatile memory unit or units. The memory 1304 may also be another form of computer-readable medium, such as a magnetic or optical disk.

The storage device 1306 is configured to provide mass storage for the computing device 1300. In one implementation, the storage device 1306 may be or may contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain (e.g., store) instructions that, when executed, perform one or more methods, such as those described above. The information carrier is a computer- or machine-readable medium, such as the memory 1304, the storage device 1306, or memory on processor 1302.

The high speed controller 1308 manages bandwidth-intensive operations for the computing device 1300, while the low speed controller 1312 manages lower bandwidth-intensive operations. Such allocation of functions is exemplary only. In one implementation, the high-speed controller 1308 is coupled to memory 1304, display 1316 (e.g., through a graphics processor or accelerator), and to high-speed expansion ports 1310, which may accept various expansion cards (not shown). In the implementation, low-speed controller 1312 is coupled to storage device 1306 and low-speed expansion port 1314. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1300 may be implemented in a number of different forms, as shown in the figure. For example, computing device 1300 may be implemented in a personal computer such as a laptop computer 1322. Alternatively, components from computing device 1300 may be combined with other components in a mobile device (not shown), such as device 1350. Each of such devices may contain one or more of computing device 1300, 1350, and an entire system may be made up of multiple computing devices 1300, 1350 communicating with each other.

Computing device 1350 includes a processor 1352, memory 1364, an input/output (I/O) device such as a display 1354, a communication interface 1366, and a transceiver 1368, among other components. The device 1350 may also be provided with a storage device, such as a micro-drive or other device, to provide additional storage. Each of the components 1350, 1352, 1364, 1354, 1366, and 1368, are interconnected using various buses, and several of the components may be mounted on a common motherboard or in other manners as appropriate.

The processor 1352 can execute instructions within the computing device 1350, including instructions stored in the memory 1364. The processor may be implemented as a chipset of chips that include separate and multiple analog and digital processors. The processor may provide, for example, for coordination of the other components of the device 1350, such as control of user interfaces, applications run by device 1350, and wireless communication by device 1350.

Processor 1352 may communicate with a user through control interface 1358 and display interface 1356 coupled to a display 1354. The display 1354 may be, for example, a TFT LCD (Thin-Film-Transistor Liquid Crystal Display) or an OLED (Organic Light Emitting Diode) display, or other appropriate display technology. The display interface 1356 may comprise appropriate circuitry for driving the display 1354 to present graphical and other information to a user. The control interface 1358 may receive commands from a user and convert them for submission to the processor 1352. In addition, an external interface 1362 may be provide in communication with processor 1352, so as to enable near area communication of device 1350 with other devices. External interface 1362 may provide, for example, for wired communication in some implementations, or for wireless communication in other implementations, and multiple interfaces may also be used.

The memory 1364 stores information within the computing device 1350. The memory 1364 can be implemented as one or more of a computer-readable medium or media, a volatile memory unit or units, or a non-volatile memory unit or units. Expansion memory 1374 may also be provided and connected to device 1350 through expansion interface 1372, which may include, for example, a SIMM (Single In Line Memory Module) card interface. Such expansion memory 1374 may provide extra storage space for device 1350, or may also store applications or other information for device 1350. Specifically, expansion memory 1374 may include instructions to carry out or supplement the processes described above, and may include secure information also. Thus, for example, expansion memory 1374 may be provide as a security module for device 1350, and may be programmed with instructions that permit secure use of device 1350. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1364, expansion memory 1374, or memory on processor 1352, that may be received, for example, over transceiver 1368 or external interface 1362.

Device 1350 may communicate wirelessly through communication interface 1366, which may include digital signal processing circuitry where necessary. Communication interface 1366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1368. In addition, short-range communication may occur, such as using a Bluetooth, WiFi, or other such transceiver (not shown). In addition, GPS (Global Positioning System) receiver module 1370 may provide additional navigation- and location-related wireless data to device 1350, which may be used as appropriate by applications running on device 1350.

Device 1350 may also communicate audibly using audio codec 1360, which may receive spoken information from a user and convert the spoken information to usable digital information. Audio codec 1360 may likewise generate audible sound for a user, such as through a speaker, e.g., in a handset of device 1350. Such sound may include sound from voice telephone calls, may include recorded sound (e.g., voice messages, music files, etc.) and may also include sound generated by applications operating on device 1350.

The computing device 1350 may be implemented in a number of different forms, as shown in the figure. For example, computing device 1350 may be implemented as a cellular telephone 1380. Computing device 1350 may also be implemented as part of a smart phone 1382, personal digital assistant, or other similar mobile device.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

What is claimed is:

1. An apparatus comprising:
a universal serial bus (USB) adapter communicatively coupled to a USB power source with a power bus;
a first controller configured to increase a current associated with the USB power source;
a second controller configured to determine a power utilization of the apparatus; and
a third controller configured to couple a battery to the power bus based on the determined power utilization such that a current associated with the USB power source does not exceed a threshold current rating of the USB power source.

2. The apparatus of claim 1, wherein the third controller provides current to the apparatus via the power bus if a power requirement of the apparatus is greater than power received from the USB power source.

3. The apparatus of claim 1, wherein
the second controller monitors an energy level of the battery and a current flow received from the USB power source via the USB adapter, and
the second controller instructs the third controller to stop current from flowing from the battery to the power output if the energy level of the battery is less then a threshold energy level and the current flow received from the USB power source is less than a threshold current level.

4. The apparatus of claim 1, wherein
the second controller is configured to monitor a voltage level of the power bus; and
the second controller is configured to send a signal to the USB adapter indicating a voltage level based on comparing the voltage level of the power bus to a desired voltage level.

5. The apparatus of claim 1, wherein
the second controller is configured to monitor a current level of the USB power source; and
the second controller is configured to send a signal to the USB adapter indicating a voltage level based on comparing the current level of the USB power source to a threshold current level.

6. The apparatus of claim 1, further comprising
a charger coupled between the battery and the power bus, the charger being configured to:
determine whether a voltage level of the power bus is less than a voltage level required to charge the rechargeable battery; and
if the voltage level of the power bus is less than a voltage level required to charge the battery, convert the voltage provided by the power output to a voltage required to charge the battery,
wherein the battery is coupled to the power bus via a first path which includes the charger and allows current to flow from the power bus to the battery and prevents current from flowing from the battery to the power bus and via a second path which bypasses the charger and allows current to flow both from the power bus to the battery and from the battery to the power output.

7. The apparatus of claim 1, wherein the second controller may instruct a processor associated with the apparatus to limit at least one processing function based on a charge remaining in the battery.

8. An apparatus comprising:
a universal serial bus (USB) adapter communicatively coupled to a USB power source with a battery;
a first controller configured to increase a current associated with the USB power source;
a second controller configured to determine a power utilization of the apparatus; and
a display configured to display a power limitation of the USB power source based on the determined power utilization.

9. The apparatus of claim 8, wherein the display displays an indicator light indicating the battery is in use.

10. The apparatus of claim 8, wherein the display displays a power meter indicating an amount of charge remaining in the battery.

11. The apparatus of claim 8, wherein the display displays a power meter indicating an amount of time remaining for use of the battery.

12. The apparatus of claim 8, wherein the display displays an icon, the icon indicating at least one of no power attached, USB power attached and will be used to extend battery life, USB power attached and will be used to charge battery or extend battery life, USB power attached and charging battery, and USB power attached and battery fully charged.

13. The apparatus of claim 8, further comprising:
a display adapter configured to set at least one display parameter, wherein
the second controller is configured to instruct the display adapter to change the at least one display parameter based on a remaining charge in the battery, the changed at least one display parameter affecting power consumption of the display.

14. The apparatus of claim 8, wherein
the second controller monitors an energy level of the battery and a current flow received from the USB power source via the USB adapter, and
the second controller instructs a third controller to stop current from flowing from the battery to the power output if the energy level of the battery is less then a threshold energy level and the current flow received from the USB power source is less than a threshold current level.

15. The apparatus of claim 8, wherein
the second controller is configured to monitor a current level of the USB power source; and
the second controller is configured to send a signal to the USB adapter indicating a voltage level based on comparing the current level of the USB power source to a threshold current level.

16. The apparatus of claim 8, further comprising
a charger coupled between the battery and the power bus, the charger being configured to:
determine whether a voltage level of the power bus is less than a voltage level required to charge the rechargeable battery; and
if the voltage level of the power bus is less than a voltage level required to charge the battery, convert the voltage provided by the power output to a voltage required to charge the battery,
wherein the battery is coupled to the power bus via a first path which includes the charger and allows current to flow from the power bus to the battery and prevents current from flowing from the battery to the power bus and via a second path which bypasses the charger and allows current to flow both from the power bus to the battery and from the battery to the power output.

17. The apparatus of claim 8, wherein the second controller may instruct a processor associated with the apparatus to limit at least one processing function based on a charge remaining in the battery.

18. The apparatus of claim 8, further comprising:
a third controller configured to couple a battery to the power bus based on the determined power utilization such that a current associated with the USB power source does not exceed a threshold current rating of the USB power source, wherein
the third controller provides current to the apparatus via the power bus if a power requirement of the apparatus is greater than power received from the USB power source.

19. A method comprising:
increasing a current associated with a universal serial bus (USB) adapter communicatively coupled to a USB power source with a battery;
determining a power utilization of a device including the USB adapter; and
displaying, on the device, a power limitation of the USB power source based on the determined power utilization.

20. The method of claim 19, further comprising:
setting at least one display parameter;
changing the at least one display parameter based on a remaining charge in a battery, the changed at least one display parameter affecting power consumption of the device.
